(19) United States
(12) Patent Application Publication
(10) Pub. No.: US 2012/0248668 A1
(43) Pub. Date: Oct. 4, 2012

(54) FLUID-FILLED VIBRATION-DAMPING DEVICE OF MULTIDIRECTIONAL VIBRATION-DAMPING TYPE

(75) Inventor: Satoshi UMEMURA, Kamo-gun (JP)

(73) Assignee: TOKAI RUBBER INDUSTRIES, LTD., Aichi (JP)

(21) Appl. No.: 13/364,616

(22) Filed: Feb. 2, 2012

(30) Foreign Application Priority Data
Mar. 28, 2011 (JP) 2011-069415

(51) Int. Cl. F16F 13/08

(52) U.S. Cl. 267/140.11

(57) ABSTRACT

A fluid-filled vibration-damping device of multidirectional vibration-damping type including: a first mounting member; a second mounting member; a main rubber elastic body connecting the two mounting members; a pressure-receiving fluid chamber; an equilibrium fluid chamber; a first orifice passage interconnecting the two fluid chambers; a plurality of outer peripheral fluid chambers situated on an outer peripheral side of the main rubber elastic body; a second orifice passage interconnecting the outer peripheral fluid chambers; and an intermediate sleeve affixed to the main rubber elastic body. The intermediate sleeve and the second mounting member each include a step portion at an axially medial section thereof, and are mated and fixed to each other at opposite sides of the corresponding step portion. The two step portions are opposed to each other in an axial direction so that the second orifice passage is formed between axially opposed faces of the step portions.

### INCORPORATED BY REFERENCE

The disclosure of Japanese Patent Application No. 2011-069415 filed on Mar. 28, 2011 including the specification, drawings and abstract is incorporated herein by reference in its entirety.

### BACKGROUND OF THE INVENTION

1. Field of the Invention

The present invention relates generally to a fluid-filled vibration-damping device which is adapted for use as an automotive engine mount or the like and utilizes vibration damping effects based on the flow action of a non-compressible fluid filling the interior. More particularly, the present invention pertains to a fluid-filled vibration-damping device of multidirectional vibration-damping type which is capable of exhibiting vibration damping effects in multiple directions including the axial direction and the axis-perpendicular direction.

2. Description of the Related Art

Fluid-filled type vibration damping devices that utilize the flow action of a non-compressible fluid filling the interior have been used as one known class of vibration damping devices for providing vibration damping support or vibration damping linkage between components that make up a vibration transmission system. Such a device is disclosed in U.S. Pat. No. 6,820,867, for example. Specifically, the fluid-filled vibration-damping device disclosed in U.S. Pat. No. 6,820,867 has a structure in which a first mounting member and a second mounting member are connected by a main rubber elastic body. Described more specifically, an intermediate sleeve is affixed to the outer circumferential face of the main rubber elastic body, and the second mounting member is mated and fixed to the intermediate sleeve. In addition, on one side of a partition member supported by the second mounting member, there is formed a pressure-receiving fluid chamber whose wall is partially defined by the main rubber elastic body, while on the other side, there is formed an equilibrium fluid chamber whose wall is partially defined by a flexible film. Besides, each of the pressure-receiving fluid chamber and the equilibrium fluid chamber is filled with a non-compressible fluid, and a first orifice passage is provided through which the pressure-receiving fluid chamber and the equilibrium fluid chamber communicate with each other. When vibration in the axial direction is input to the pressure-receiving fluid chamber, fluid flow will be induced between the two chambers through the first orifice passage, thereby exhibiting vibration damping effect on the basis of resonance action etc. of the fluid.

In the fluid-filled vibration-damping device of U.S. Pat. No. 6,820,867, with the aim of enhancing vibration damping ability in the axis-perpendicular direction, there are also formed a plurality of outer peripheral fluid chambers filled with a non-compressible fluid, and a second orifice passage through which the outer peripheral fluid chambers communicate with one another. Specifically, a plurality of window portions are formed in the intermediate sleeve, and a plurality of pocket portions formed in the main rubber elastic body open onto the outer circumferential face through the window portions. The second mounting member covers the plurality of window portions so as to provide the plurality of outer peripheral fluid chambers filled with a non-compressible fluid. Additionally, an orifice member extending in the circumferential direction is fitted into the window portions. With this arrangement, the second orifice passage for connecting the outer peripheral fluid chambers is formed between the orifice member and the second mounting member, and extends in the circumferential direction. Upon input of vibration in the axis-perpendicular direction, a relative pressure differential will arise among the plurality of outer peripheral fluid chambers. This will induce fluid flow through the second orifice passage among the outer peripheral fluid chambers, thereby exhibiting vibration damping effect based on the flow action of the fluid.

However, with respect to the above-described fluid-filled vibration-damping device of bi-directional vibration-damping type as disclosed in U.S. Pat. No. 6,820,867, a special orifice member is needed in order to afford vibration damping effect in the axis-perpendicular direction. This may pose a risk of problem such as an increased number of components or a complicated construction. Moreover, in the construction taught by U.S. Pat. No. 6,820,867, the orifice member comprises two components of semicircular ring shape that are attached to the respective window portions from opposite sides in the diametrical directions. Consequently, the number of components increases even more, and an operation step for attaching the orifice member is especially needed.

Meanwhile, Japanese Unexamined Patent Publication No. JP-A-2003-120746 discloses another fluid-filled vibration-damping device of bi-directional vibration-damping type, wherein the lower end of an intermediate sleeve has a shape of concave groove that opens onto the outer circumferential face, and the outer circumferential opening of the groove is covered with a second mounting member so that a second orifice passage is formed between the intermediate sleeve and the second mounting member. However, in order to obtain the intermediate sleeve of special configuration having such a groove, an additional process step is needed for providing the groove, posing a risk of being unable to sufficiently meet the requirements for facility in fabrication.

### SUMMARY OF THE INVENTION

It is therefore one object of this invention to provide a fluid-filled vibration-damping device of multidirectional vibration-damping type with a novel constitution which is able to exhibit vibration damping effect with respect to vibration in the axial direction as well as vibration in the axis-perpendicular direction, with a small number of parts and through a simple structure.

Specifically, a first mode of the present invention provides a fluid-filled vibration-damping device of multidirectional vibration-damping type including: a first mounting member; a second mounting member having a tubular shape so that the first mounting member is positioned at a first axial opening side of the second mounting member; a main rubber elastic body connecting the first mounting member and the second mounting member; a pressure-receiving fluid chamber situated at one axial side of the main rubber elastic body and whose wall is partially defined by the main rubber elastic body; an equilibrium fluid chamber whose wall is partially defined by a flexible film; a first orifice passage through which the pressure-receiving fluid chamber and the equilibrium fluid chamber communicate with each other; a plurality of outer peripheral fluid chambers situated on an outer peripheral side of the main rubber elastic body; a second orifice passage through which the plurality of outer peripheral fluid chambers communicate with one another; an intermediate sleeve affixed to an outer circumferential face of the main rubber elastic body, the intermediate sleeve and the second mounting member each having a stepped tubular shape that includes a step portion at an axially medial section thereof while the intermediate sleeve and the second mounting member being mated and fixed to each other at respective axially-opposite tubular portions positioned on opposite sides of the corresponding step portion; a plurality of window portions formed in the intermediate sleeve; and a plurality of pocket portions that are formed in an outer peripheral portion of the main rubber elastic body and open through the plurality of window portions so as to form the plurality of outer peripheral fluid chambers by means of the plurality of window portions of the intermediate sleeve being covered with the second mounting member, wherein the step portion of the intermediate sleeve and the step portion of the second mounting member are opposed to each other in an axial direction so that the second orifice passage is formed between axially opposed faces of the step portions.

In the fluid-filled vibration-damping device of multidirectional vibration-damping type of construction according to the first mode, the second orifice passage that connects the outer peripheral fluid chambers is formed between axially opposed faces of the step portion of the intermediate sleeve and the step portion of the second mounting member. With this arrangement, the second orifice passage which exhibits vibration damping effect with respect to vibration in the axis-perpendicular direction is formed by mating and fixing the second mounting member and the intermediate sleeve each having a stepped tubular shape, without needing any special components for forming the orifice. Therefore, it is possible to realize a fluid-filled vibration-damping device of multidirectional vibration-damping type which is able to achieve effective vibration damping effect with respect to each of vibrations input in multiple directions, namely, the axial direction and the axis-perpendicular direction, through a simple structure with a small number of parts.

In addition, the intermediate sleeve and the second mounting member are mated and fixed to each other at respective axially-opposite tubular portions positioned on opposite sides of the corresponding step portion. Thus, the second mounting member and the intermediate sleeve are able to obtain sufficient sealing in between. Accordingly, fluid flow through the second orifice passage will be efficiently produced, thereby effectively exhibiting vibration damping action based on resonance action etc. of the fluid.

Moreover, both the second mounting member and the intermediate sleeve do not need to have any complicated configuration for forming the second orifice passage, but are allowed to have a stepped tubular shape that is easy to produce. This facilitates to produce the second mounting member and the intermediate sleeve, thereby preventing a complicated construction or increase of the number of process steps.

A second mode of the present invention provides the fluid-filled vibration-damping device of multidirectional vibration-damping type according to the first mode wherein: the outer circumferential face of the main rubber elastic body has tapered contours that gradually spread and extend in the axial direction from the first mounting member toward the second mounting member; a plurality of rubber elastic films extend from a middle section of the outer circumferential face of the main rubber elastic body so as to be affixed to the intermediate sleeve; the plurality of outer peripheral fluid chambers each have a wall partially defined by each of the rubber elastic films; and the rubber elastic films each have curving contours whose slope angle with respect to an axis-perpendicular direction progressively becomes larger toward the outer peripheral side viewed in vertical cross section.

According to the second mode, the rubber elastic films extend from the middle section of the outer circumferential face of the main rubber elastic body of tapered contours. Consequently, with respect to vibration input in the axis-perpendicular direction, sufficient fluid flow between the outer peripheral fluid chambers through the second orifice passage will be ensured. Simultaneously, a sufficient free length of the rubber elastic film is obtained, whereby durability of the rubber elastic film will also be ensured. In this way, both vibration damping ability and enduring performance will be afforded.

Besides, since the rubber elastic films each have curving contours, a larger free length of the rubber elastic film is obtained, thereby further improving durability.

A third mode of the present invention provides the fluid-filled vibration-damping device of multidirectional vibration-damping type according to the second mode wherein the plurality of rubber elastic films are provided independently of one another in a circumferential direction.

According to the third mode, the rubber elastic films are provided independently of one another in the circumferential direction so that there are formed gaps circumferentially among the plurality of outer peripheral fluid chambers. Thus, during input of vibration in the axis-perpendicular direction, the rubber elastic film will be permitted deformation without being restrained, thereby improving durability. Moreover, since no solid partition wall is formed circumferentially among the outer peripheral fluid chambers, it is possible to prevent situations where the spring constant becomes markedly greater in a specific diametrical direction. Consequently, a high degree of freedom in tuning spring characteristics is afforded.

A fourth mode of the present invention provides the fluid-filled vibration-damping device of multidirectional vibration-damping type according to any one of the first through third modes wherein in the intermediate sleeve, the window portion including the step portion has a notched portion in a frame thereof, and the second orifice passage communicates with the outer peripheral fluid chamber through the notched portion.

According to the fourth mode, the second orifice passage communicates with the outer peripheral fluid chamber through the notched portion provided in the frame of the window portion including the step portion. Thus, a large area for mating and fixing the second mounting member and the intermediate sleeve will be obtained. Therefore, the second mounting member and the intermediate sleeve are firmly fixed and are reliably sealed at the mating area, so that enhanced fluid tightness of the outer peripheral fluid chambers and the second orifice passage will be attained.

A fifth mode of the present invention provides the fluid-filled vibration-damping device of multidirectional vibration-damping type according to any one of the first through fourth modes wherein: the second mounting member and the intermediate sleeve each have a stepped oval tubular shape; the plurality of outer peripheral fluid chambers comprise a pair of the outer peripheral fluid chambers; and the pair of the outer peripheral fluid chambers are positioned on opposite sides in a major axis direction of the second mounting member viewed in the axial direction.

According to the fifth mode, a large volume of the pair of outer peripheral fluid chambers is efficiently ensured, while the first mounting member and the second mounting member will obtain a sufficient amount of relative displacement in the major axis direction of the second mounting member. Therefore, discharge efficiency of the fluid in the pair of outer peripheral fluid chambers will be enhanced, thereby advantageously exhibiting vibration damping effect on the basis of the flow action of the fluid. Furthermore, in the minor axis direction that is perpendicular to the direction of opposition of the outer peripheral fluid chambers, it is possible to avoid increase in the outside diameter dimension of the device. Accordingly, in comparison with the case in which the second mounting member has a circular tubular shape, the device will require less space for its disposition.

According to the present invention, the second mounting member and the intermediate sleeve each having a stepped tubular shape including the step portion are mated and fixed together so that the second orifice passage for connecting the outer peripheral fluid chambers is provided between opposed faces of the step portions. Therefore, the second orifice passage is formed without any special orifice member or the like, and the fluid-filled vibration-damping device which exhibits effective vibration damping action with respect to vibrations input in multiple directions is realized through a simple structure with a small number of parts.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is an elevational view in axial or vertical cross section of a fluid-filled vibration-damping device of multidirectional vibration-damping type in the form of an engine mount, which is constructed according to a first embodiment of the present invention, taken along line 1-1 of FIG. 3;

FIG. 2 is an elevational view in axial or vertical cross section of the engine mount of FIG. 1, taken along line 2-2 of FIG. 3;

FIG. 3 is a top plane view of the engine mount of FIG. 1; and

FIG. 4 is a perspective view of an intermediate sleeve of the engine mount of FIG. 1.

### DETAILED DESCRIPTION OF PREFERRED EMBODIMENTS

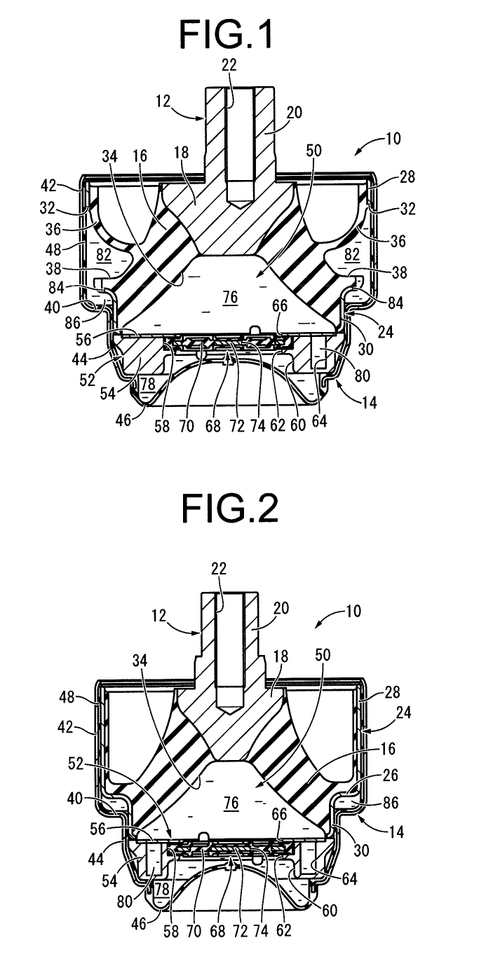

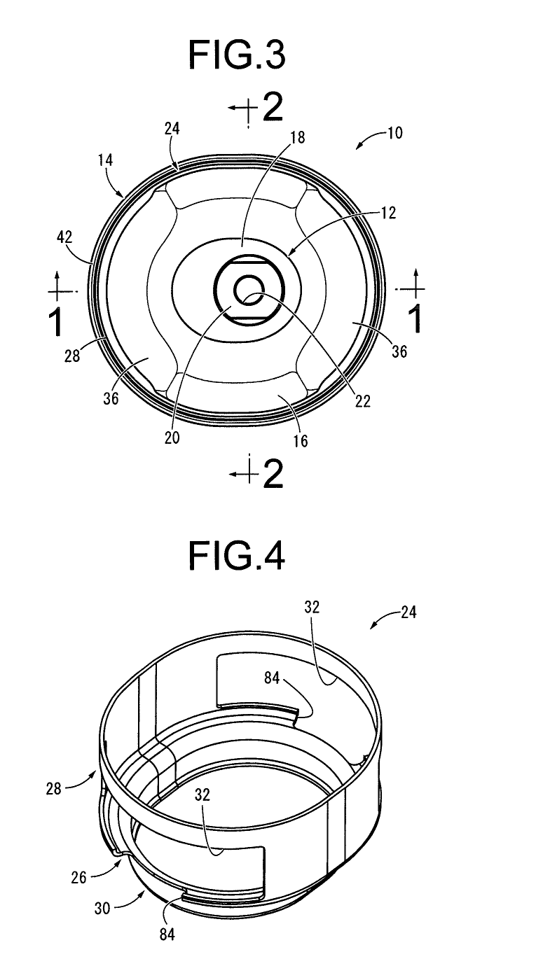

Referring to FIGS. 1 through 3, there is depicted an automotive engine mount 10 according to a first embodiment of a fluid-filled vibration-damping device of multidirectional vibration-damping type constructed in accordance with the present invention. The engine mount 10 has a construction in which a first mounting member 12 and a second mounting member 14 are connected by a main rubber elastic body 16. In the following descriptions, unless otherwise indicated, the “vertical direction” refers to the vertical direction in FIG. 1, which coincides with the axial direction. In addition, the “lengthwise direction” refers to the lateral direction in FIG. 1, which coincides with the vehicle lengthwise direction when mounted onto the vehicle. Also, the “lateral direction” refers to the lateral direction in FIG. 2, which coincides with the vehicle lateral direction when mounted onto the vehicle.

Described more specifically, the first mounting member 12 is a high rigidity component which is integrally equipped with an anchor portion 18 of generally inverted oval frustoconical shape and a fastening shaft 20 of pillar shape projecting upward from the anchor portion 18. The first mounting member 12 includes a bolt hole 22 opening onto the upper face of the fastening shaft 20. The bolt hole 22 is provided with a screw thread on its inside peripheral face. Note that the basal end section of the fastening shaft 20 has a generally circular post shape while the upper section thereof is provided with opposing flats, which makes the upper section narrower in its lateral direction than in its lengthwise direction. Additionally, the center axis of the anchor portion 18 and the center axis of the fastening shaft 20 are deviated from each other in the major axis direction of the anchor portion 18. The center axis of the anchor portion 18 is the mount center axis which coincides with the center axis of the second mounting member 14 and the main rubber elastic body 16.

An intermediate sleeve 24 which is shown in FIG. 4 is disposed at the outer peripheral side of the first mounting member 12. The intermediate sleeve 24 is a tubular body that has a generally oval annular shape in plan view, and is provided with a step portion 26 at its axially medial section. With this arrangement, the intermediate sleeve 24 has a generally stepped oval tubular shape of thin-walled, large-diameter configuration. The upper side of the step portion 26 defines an inner circumferential large-diameter tubular portion 28, and the lower side of the step portion 26 defines an inner circumferential small-diameter tubular portion 30. Note that the inner circumferential large-diameter tubular portion 28 and the inner circumferential small-diameter tubular portion 30 serve as axially-opposite tubular sections positioned on opposite sides of the step portion 26 of the intermediate sleeve 24.

Moreover, the intermediate sleeve 24 includes a pair of window portions 32, 32. The window portion 32 is formed so as to perforate the inner circumferential large-diameter tubular portion 28 of the intermediate sleeve 24 in the diametrical direction, and extends with a length less than half the circumference thereof in the circumferential direction. Note that the pair of window portions 32, 32 are positioned at portions opposed to each other in one diametrical direction.

The anchor portion 18 of the first mounting member 12 is inserted from the upper opening of the inner circumferential large-diameter tubular portion 28 of the intermediate sleeve 24 and spaced apart therefrom in the diametrical direction, and the first mounting member 12 and the intermediate sleeve 24 are connected by the main rubber elastic body 16. The main rubber elastic body 16 is of thick-walled, large-diameter, generally oval frustoconical shape. The outer circumferential face of the main rubber elastic body 16 has tapered contours that gradually spread and extend in the axial direction from the first mounting member 12 toward the second mounting member 14. The anchor portion 18 of the first mounting member 12 is bonded by vulcanization to the small-diameter side end of the main rubber elastic body 16, while the inner circumferential face of the intermediate sleeve 24 is superposed against and bonded by vulcanization to the outer circumferential face of the large-diameter side end of the main rubber elastic body 16. By so doing, the first mounting member 12 and the intermediate sleeve 24 are elastically connected by the main rubber elastic body 16. In the present embodiment, the main rubber elastic body 16 takes the form of an integrally vulcanization molded component incorporating the first mounting member 12 and the intermediate sleeve 24.

Additionally, the main rubber elastic body 16 includes a center recess 34. The center recess 34 is a recess of inverted, generally bowl shape that progressively flares towards the bottom, and opens onto the large-diameter side end face of the main rubber elastic body 16.

Furthermore, a pair of rubber elastic films 36, 36 are integrally formed with the main rubber elastic body 16. The each rubber elastic film 36 is a rubber elastic body of thin-walled film shape that extends from the medial section of the outer circumferential face of the main rubber elastic body 16 toward the outer peripheral side. In addition, when viewed in vertical cross section as shown in FIG. 1, the each rubber elastic film 36 has curving contours whose slope angle with respect to the horizontal surface progressively becomes larger toward the outer peripheral side, and has an ample slack. The pair of rubber elastic films 36, 36 extend from the outer circumferential face of the main rubber elastic body 16 toward opposite directions in one diametrical direction, and are separately provided in the circumferential direction so as to be independent of each other.

Furthermore, each outer peripheral edge of the pair of rubber elastic films 36, 36 is bonded by vulcanization to the upper frame and the side frames of the corresponding window portion 32 of the intermediate sleeve 24. Besides, two circumferential ends of each rubber elastic film 36 are integrally connected with the outer circumferential face of the main rubber elastic body 16. With this arrangement, in the outer peripheral section of the main rubber elastic body 16, a pair of pocket portions 38, 38 that are fluid-tightly closed by the rubber elastic films 36, 36 and the main rubber elastic body 16 open onto the outer peripheral side through the window portions 32. Note that the pair of rubber elastic films 36, 36 are provided at the positions that correspond to the positions of the pair of window portions 32, 32 on the circumference, so that the pair of pocket portions 38, 38 that are opposed to each other in one diametrical direction are formed in the main rubber elastic body 16.

Meanwhile, the second mounting member 14 is attached to the intermediate sleeve 24. The second mounting member 14 is a tubular body having a generally oval annular shape in plan view, and is a high rigidity component similar to the first mounting member 12. The second mounting member 14 is provided with a step portion 40 at its axially medial section. The upper side of the step portion 40 defines an outer circumferential large-diameter tubular portion 42 while the lower side of the step portion 40 defines an outer circumferential small-diameter tubular portion 44, so that the second mounting member 14 has a generally stepped oval tubular shape overall. Note that the outer circumferential large-diameter tubular portion 42 and the outer circumferential small-diameter tubular portion 44 serve as axially-opposite tubular sections positioned on opposite sides of the step portion 40 of the second mounting member 14.

Moreover, a flexible film 46 is affixed to the second mounting member 14. The flexible film 46 is a thin-walled rubber film having a generally dome shape, and has an ample slack in the vertical direction. The flexible film 46 is disposed so as to cover the lower opening of the second mounting member 14, with its outer peripheral edge bonded by vulcanization to the lower end section of the outer circumferential small-diameter tubular portion 44 of the second mounting member 14. Note that the rubber elastic films 36 according to the present embodiment are made thicker than the flexible film 46.

Besides, a seal rubber layer 48 is formed so as to cover the inner circumferential face of the second mounting member 14. The seal rubber layer 48 is a thin-walled rubber elastic body that is integrally formed with the flexible film 46, and is bonded by vulcanization to so as to cover generally the entire inner circumferential face of the second mounting member 14.

The second mounting member 14 including the flexible film 46 affixed thereto is attached fitting around the intermediate sleeve 24 of the integrally vulcanization molded component of the main rubber elastic body 16. Specifically, the second mounting member 14 is externally fitted around the intermediate sleeve 24 from below and then is subjected to a diameter reduction process such as 360-degree radial compression. By so doing, the second mounting member 14 is mated and fixed to the intermediate sleeve 24 via the seal rubber layer 48. With the seal rubber layer 48 sandwiched between juxtaposed faces of the second mounting member 14 and the intermediate sleeve 24, the second mounting member 14 is fluid-tightly attached to the intermediate sleeve 24.

With the second mounting member 14 fluid-tightly attached to the intermediate sleeve 24 as described above, there is formed a fluid-filled zone 50 between axially opposed faces of the main rubber elastic body 16 and the flexible film 46, which is sealed off from the outside. The fluid-filled zone 50 is filled with a non-compressible fluid. While no particular limitation is imposed as to the non-compressible fluid filling the fluid-filled zone 50, preferred examples are water, alkylene glycols, polyalkylene glycols, silicone oil, and mixtures of these. In terms of efficiently achieving vibration damping action based on flow action of the fluid described later, a low-viscosity fluid having viscosity of 0.1 Pa·s or lower is especially preferred.

Besides, a partition member 52 is disposed within the fluid-filled zone 50. The partition member 52 is of thick-walled, generally oval circular disk shape overall, and has a construction in which a partition member body 54 and a cover member 56 are assembled together. The partition member body 54 has a thick-walled, generally oval circular disk shape. In the diametrically center section of the partition member body 54, there are formed a housing recess 58 opening onto its upper face, a circular recess 60 opening onto its lower face, and a lower through hole 62 perforating the upper wall of the circular recess 60. Moreover, in the outside peripheral section of the partition member body 54, there is formed a circumferential groove 64 that opens onto its upper face and extends for a prescribed length just short of once around the circumference. Meanwhile, the cover member 56 has a thin-walled, generally oval circular disk shape. In the diametrically center section of the cover member 56, there is formed an upper through hole 66 whose diameter is smaller than that of the housing recess 58.

The cover member 56 is superposed against the upper face of the partition member body 54, and the two components are secured to each other by means such as pinning, screwing, caulking or the like. In addition, a movable member 68 is disposed between the partition member body 54 and the cover member 56. The movable member 68 has a construction in which an elastic rubber plate 70 of generally circular disk shape includes a reinforcing member 72 embedded therein. The reinforcing member 72 is made of metal or synthetic resin, and has a thin-walled plate shape. Moreover, the reinforcing member 72 of the movable member 68 includes a plurality of passage holes 74. The passage holes 74 are closed off by a part of the elastic rubber plate 70. The movable member 68 is inserted into the housing recess 58, and the cover member 56 is secured to the partition member body 54. With this arrangement, the movable member 68 is permitted to undergo tiny displacement in the vertical direction between the partition member body 54 and the cover member 56, while an amount of its displacement is limited by abutment against the partition member body 54 or the cover member 56.

The partition member 52 of the above construction is disposed within the fluid-filled zone 50 and supported by the second mounting member 14. Described more specifically, the partition member 52 is positioned in the diametrical direction with its outer circumferential face held in contact against the inner circumferential face of the second mounting member 14, while being positioned in the axial direction with its outer peripheral portion sandwiched between the lower end of the intermediate sleeve 24 and an inner flanged portion provided to the lower end of the second mounting member 14. By so doing, the partition member 52 is disposed within the fluid-filled zone 50 so as to spread in the axis-perpendicular direction, and is supported by the second mounting member 14.

With the partition member 52 disposed in this way, the fluid-filled zone 50 is bifurcated into upper and lower parts by the partition member 52. Specifically, the axially upper side of the partition member 52 provides a pressure-receiving fluid chamber 76 whose wall is partially defined by the main rubber elastic body 16 and that is subjected to internal pressure fluctuations during input of vibration. Meanwhile, the axially lower side of the partition member 52 provides an equilibrium fluid chamber 78 whose wall is partially defined by the flexible film 46 and that permits changes in volume on the basis of elastic deformation of the flexible film 46. The pressure-receiving fluid chamber 76 and the equilibrium fluid chamber 78 are both filled with the non-compressible fluid filling the fluid-filled zone 50.

Additionally, the opening of the circumferential groove 64 formed in the partition member body 54 is covered by the cover member 56 so as to provide a tunnel-like passage. One end of the tunnel-like passage communicates with the pressure-receiving fluid chamber 76 via an upper communication hole (not shown) perforating the cover member 56, while the other end of the tunnel-like passage communicates with the equilibrium fluid chamber 78 via a lower communication hole (not shown) perforating the bottom wall of the circumferential groove 64. With this arrangement, a first orifice passage 80 that interconnects the pressure-receiving fluid chamber 76 and the equilibrium fluid chamber 78 is formed by utilizing circumferential groove 64. While not limited in any particular way, in the present embodiment, the first orifice passage 80 is tuned to low frequency of around 10 Hz that corresponds to an engine shake.

On the other hand, with the second mounting member 14 attached to the intermediate sleeve 24, the pair of window portions 32, 32 formed in the intermediate sleeve 24 are covered by the outer circumferential large-diameter tubular portion 42 of the second mounting member 14. Accordingly, the outer peripheral openings of the pair of the pocket portions 38, 38 formed in the main rubber elastic body 16 are fluid-tightly covered. With this arrangement, in the outer peripheral side of the main rubber elastic body 16, there are formed a pair of outer peripheral fluid chambers 82, 82 each having a wall partially defined by each of the rubber elastic films 36, by utilizing the pair of the pocket portions 38, 38. The pair of outer peripheral fluid chambers 82, 82 are positioned on opposite sides in the major axis direction of the second mounting member 14 in plan view, being independent of each other in the circumferential direction. The pair of outer peripheral fluid chambers 82, 82 are filled with a non-compressible fluid similar to that filling the pressure-receiving fluid chamber 76 and the equilibrium fluid chamber 78. The outer peripheral fluid chambers 82 each have a circumferential length less than half the entire circumference. In preferred practice, the circumferential length is arranged such that the angle around the center axis is 30 degrees or greater, and less than 120 degrees.

The step portion 26 of the intermediate sleeve 24 and the step portion 40 of the second mounting member 14 are opposed to each other in the vertical direction so as to form a spacing in between. Accordingly, an annular tunnel-like passage is provided between the opposed faces of the step portions 26, 40. Besides, the passage communicates with the pair of outer peripheral fluid chambers 82 through a pair of notched portions 84, 84 formed in the lower frame of the each window portion 32 including the step portion 26, thereby forming a pair of half-annular passages whose both ends communicate with the pair of outer peripheral fluid chambers 82, 82 via the notched portions 84, 84. As shown in FIG. 4, the notched portion 84 is provided in substantially the center section of the circumference of the window portion 32 by notching the lower frame of the window portion 32. Note that the notched portion 84 reaches the step portion 26 positioned below the lower frame of the window portion 32 so as to perforate a part of the circumference of the step portion 26 in the vertical direction. With this arrangement, a second orifice passage 86 that interconnects the pair of outer peripheral fluid chambers 82, 82 is formed between opposed faces of the step portions 26, 40. The second orifice passage 86 is tuned to low frequency of around 10 Hz that corresponds to a crank vibration generated during engine startup, a vibration caused thereby, or the like. It should be appreciated that the second orifice passage 86 is provided by assembling the integrally vulcanization molded component of the main rubber elastic body 16, the integrally vulcanization molded component of the flexible film 46, and the partition member 52, without any special components.

The engine mount 10 of the above construction is mounted onto an automobile by, for example, the first mounting member 12 being attached to a power unit (not shown) via an inner bracket (not shown) and the second mounting member 14 being attached to a vehicle body (not shown) via an outer bracket (not shown), thereby providing vibration damping linkage of the power unit on the vehicle body.

When vibration is input with the engine mount 10 mounted onto the vehicle, vibration damping effect will be exhibited based on flow action or the like of the fluid. In the present embodiment in particular, effective vibration damping action will be achieved with respect to not only the vibration in the axial direction but also the vibration in one diametrical direction along which the pair of outer peripheral fluid chambers 82, 82 are opposed to each other.

Specifically, when a low-frequency, large-amplitude vibration corresponding to an engine shake is input in the axial direction, relative pressure differential will arise between the pressure-receiving fluid chamber 76 and the equilibrium fluid chamber 78, whereby fluid flow will actively take place between the two fluid chambers 76, 78 through the first orifice passage 80. Accordingly, desired vibration damping effect (high attenuating or damping action) will be exhibited based on resonance action or other flow action of the fluid. Note that during input of the low-frequency, large-amplitude vibration, the movable member 68 is pressed against the upper or lower wall face within the housing space of the partition member 52 and restrained. Thus, fluid flow through the through holes 66, 62 is prevented, so that sufficient fluid flow through the first orifice passage 80 will be ensured. If a large jarring load is input and marked negative pressure of a level for which cavitation will become a problem is applied to the pressure-receiving fluid chamber 76, as to the elastic rubber plate 70 of the movable member 68, a part of the reinforcing member 72 that covers the passage hole 74 undergoes elastic deformation. Consequently, negative pressure within the pressure-receiving fluid chamber 76 will be moderated, thereby minimizing occurrence of noise due to cavitation.

When a midrange- to high-frequency, small-amplitude vibration corresponding to an idling vibration or driving rumble is input in the axial direction, relative pressure fluctuations arising between the pressure-receiving fluid chamber 76 and the equilibrium fluid chamber 78 induces vertical tiny displacement of the movable member 68 in the axial direction. Accordingly, fluid pressure of the pressure-receiving fluid chamber 76 will be transmitted to the equilibrium fluid chamber 78. Then, the flexible film 46 undergoes deformation so as to exhibit liquid pressure-absorbing action for absorbing the fluid pressure transmitted from the pressure-receiving fluid chamber 76 to the equilibrium fluid chamber 78. Therefore, desired vibration damping effect (low dynamic spring effect) will be obtained. As to the first orifice passage 80, when vibration of higher frequency than its tuning frequency is input, the first orifice passage 80 is substantially blocked due to antiresonance. Thus, a liquid pressure absorption mechanism provided by including the movable member 68 will exhibit efficient vibration damping effect.

On the other hand, a low-frequency, large-amplitude vibration corresponding a crank vibration etc. during engine startup is input in the axis-perpendicular direction, the main rubber elastic body 16 and the rubber elastic films 36 undergo elastic deformation, so that relative pressure fluctuations will arise between the pair of outer peripheral fluid chambers 82, 82. By so doing, fluid flow through the second orifice passage 86 will be produced between the pair of outer peripheral fluid chambers 82, 82, thereby attaining desired vibration damping effect (high attenuating or damping action) based on flow action of the fluid. As will be apparent from the above description, the engine mount 10 functions as an engine mount of bi-directional vibration-damping type, which is capable of achieving effective vibration damping effect with respect to vibration input in two directions.

In the engine mount 10 of this construction according to the present embodiment, the second orifice passage 86 that interconnects the pair of outer peripheral fluid chambers 82, 82 is provided between opposed faces of the step portion 40 of the second mounting member 14 and the step portion 26 intermediate sleeve 24. Therefore, there is no need to employ a special orifice member for providing the second orifice passage 86. This makes it possible to realize the engine mount 10 of bi-directional vibration-damping type which is able to obtain vibration damping effect with respect to vibration input in two directions with a small number of parts.

Additionally, the second orifice passage 86 can be provided by the outer circumferential large-diameter tubular portion 42 and the outer circumferential small-diameter tubular portion 44 of the second mounting member 14 being mated and fixed to the inner circumferential large-diameter tubular portion 28 and the inner circumferential small-diameter tubular portion 30 of the intermediate sleeve 24 respectively. The manufacture will be facilitated thereby. Moreover, the second mounting member 14 and the intermediate sleeve 24 each have a stepped tubular shape. This facilitates the manufacture of the second mounting member 14 and the intermediate sleeve 24 as well.

Besides, the pair of outer peripheral fluid chambers 82, 82 are opposed to each other in one diametrical direction, which coincides with the major axis direction of the second mounting member 14 having an oval tubular shape. This arrangement ensures a large volume of the outer peripheral fluid chambers 82, 82, so that the first mounting member 12 and the second mounting member 14 will obtain a sufficient amount of relative displacement in the axis-perpendicular direction. At the same time, the outside diameter dimension of the engine mount 10 is made small in the other diametrical direction that is perpendicular to the direction of opposition of the outer peripheral fluid chambers 82, 82. Therefore, it is possible to achieve sufficient vibration damping effect with respect to the vibration input, while minimizing space required for disposing the engine mount 10.

Furthermore, the rubber elastic films 36, which partially define the walls of the pair of outer peripheral fluid chambers 82, 82, extend from the medial section of the main rubber elastic body 16. This arrangement obtains a large free length of the rubber elastic films 36, thereby improving durability. At the same time, the rubber elastic films 36 will undergo a sufficient deformation during input of vibration, thereby producing effective fluid flow through the second orifice passage 86. That is, both excellent durability and desired vibration damping ability will be realized.

In addition, the each rubber elastic film 36 has curving contours when viewed in vertical cross section and has ample slack. Accordingly, tensile force acting on the rubber elastic film 36 during input of vibration in the diametrical direction will be reduced, further improving durability.

Also, the pair of rubber elastic films 36, 36 are provided independently of each other in the circumferential direction, making gaps circumferentially between the pair of rubber elastic films 36, 36. With this arrangement, the pair of rubber elastic films 36, 36 independently undergo elastic deformation during input of vibration in the diametrical direction, so that relative pressure differential between the pair of outer peripheral fluid chambers 82, 82 will efficiently arise. Therefore, sufficient fluid flow between the pair of outer peripheral fluid chambers 82, 82 through the second orifice passage 86 will be obtained, thereby advantageously attaining vibration damping effect based on flow action of the fluid.

Moreover, there is provided the gaps circumferentially between the pair of rubber elastic films 36, 36. Thus, in the diametrical direction that is perpendicular to the direction of opposition of the pair of outer peripheral fluid chambers 82, 82, the outer peripheral side of the main rubber elastic body 16 defines an empty space. Accordingly, the spring in the above-mentioned diametrical direction is made small. This will attain a greater degree of freedom in tuning a spring ratio between the two directions perpendicular to each other, making it possible to surely realize the required vibration damping characteristics.

Besides, the second orifice passage 86 communicates with the outer peripheral fluid chambers 82 via the notched portions 84 each formed in the lower frame of the corresponding window portion 32 including the step portion 26. With this arrangement, the communication between the pair of outer peripheral fluid chambers 82, 82 through the second orifice passage 86 is realized while obtaining sufficient mating area between the second mounting member 14 and the intermediate sleeve 24. Also, by obtaining the sufficient mating area between the second mounting member 14 and the intermediate sleeve 24, sealing performance will be enhanced.

Furthermore, the flexible film 46 is bonded by vulcanization directly to the second mounting member 14. Thus, the number of parts is reduced in comparison with the case where a fitting is anchored to the outer peripheral edge of the flexible film 46 and then secured to the second mounting member 14. A simple assembly operation will be realized as well.

While the present invention has been described hereinabove in terms of a certain preferred embodiment, the invention shall not be construed as limited in any way to the specific disclosures in the embodiments. For example, the outer peripheral fluid chambers 82 are not necessarily provided in pairs opposed to each other in one diametrical direction. Three or more outer peripheral fluid chambers 82 may be provided. Where three outer peripheral fluid chambers 82 are provided, the second orifice passage 86 comprises two passages that connect one outer peripheral fluid chamber 82 to the other two outer peripheral fluid chambers 82, for example. Alternatively, where three or more outer peripheral fluid chambers 82 are provided, it would also be possible that passages for interconnecting the outer peripheral fluid chambers 82 are formed so as to cooperatively define the second orifice passage 86, and that fluid flow is adapted to be produced depending on the input direction of vibration or the like.

Also, whereas it is desirable that the rubber elastic films 36 extend from the middle section of the outer circumferential face of the main rubber elastic body 16 in order to achieve both durability and vibration damping ability, it would also be acceptable for the rubber elastic films 36, for example, to extend from the upper end section of the outer circumferential face of the main rubber elastic body 16. That is, the location in the main rubber elastic body 16 from which the rubber elastic films 36 extend can be adjusted depending on the balance between the required enduring performance and vibration damping ability or the like. Note that the cross sectional shape of the rubber elastic films 36 in vertical cross section can also be established depending on the required characteristics. For example, a linear shape that extends in the substantially axis-perpendicular direction could also be employed.

Moreover, the second mounting member 14, intermediate sleeve 24, or the like are not limited to have an oval tubular shape, provided that it is a tubular shape. As the shape in plan view, a circular shape, a rounded rectangular shape, or the like would also be employable. As a specific example, if the second mounting member 14 and the intermediate sleeve 24 each have a circular tubular shape, alignment in the circumferential direction is not necessary during assembly operation, so that the assembly will become easier. Note that the anchor portion 18 of the first mounting member 12 and the main rubber elastic body 16 are not limited to have an oval shape in plan view either. A circular shape, a rounded rectangular shape, or the like that corresponds to the shapes of the second mounting member 14 and the intermediate sleeve 24 could also be employed.

Furthermore, it is desirable that the pair of rubber elastic films 36, 36 that define the walls of the pair of outer peripheral fluid chambers 82, 82 are formed so as to be independent of each other in the circumferential direction. However, it may alternatively be possible that, for example, a plurality of outer peripheral fluid chambers 82 are partitioned by rubber elastic films of partition-wall shape which are integrally formed with the main rubber elastic body 16. Not all the rubber elastic films that define the each wall of the outer peripheral fluid chambers 82 are necessarily independent of one another.

The fluid-filled vibration-damping device of multidirectional vibration-damping type according to the present invention is not limited to an engine mount only, and is adaptable to implementation in sub-frame mounts, body mounts, differential mounts or the like. Nor is the present invention limited to application in an automotive fluid-filled type vibration damping device, and may be implemented analogously in fluid-filled type vibration damping devices for use in motorized two wheeled vehicles, rail vehicles, industrial vehicles, or the like.

What is claimed is:

1. A fluid-filled vibration-damping device of multidirectional vibration-damping type comprising:
a first mounting member;
a second mounting member having a tubular shape so that the first mounting member is positioned at a first axial opening side of the second mounting member;
a main rubber elastic body connecting the first mounting member and the second mounting member;
a pressure-receiving fluid chamber situated at one axial side of the main rubber elastic body and whose wall is partially defined by the main rubber elastic body;
an equilibrium fluid chamber whose wall is partially defined by a flexible film;
a first orifice passage through which the pressure-receiving fluid chamber and the equilibrium fluid chamber communicate with each other;
a plurality of outer peripheral fluid chambers situated on an outer peripheral side of the main rubber elastic body;
a second orifice passage through which the plurality of outer peripheral fluid chambers communicate with one another;
an intermediate sleeve affixed to an outer circumferential face of the main rubber elastic body, the intermediate sleeve and the second mounting member each having a stepped tubular shape that includes a step portion at an axially medial section thereof while the intermediate sleeve and the second mounting member being mated and fixed to each other at respective axially-opposite tubular portions positioned on opposite sides of the corresponding step portion;
a plurality of window portions formed in the intermediate sleeve; and
a plurality of pocket portions that are formed in an outer peripheral portion of the main rubber elastic body and open through the plurality of window portions so as to form the plurality of outer peripheral fluid chambers by means of the plurality of window portions of the intermediate sleeve being covered with the second mounting member,
wherein the step portion of the intermediate sleeve and the step portion of the second mounting member are opposed to each other in an axial direction so that the second orifice passage is formed between axially opposed faces of the step portions.

2. The fluid-filled vibration-damping device of multidirectional vibration-damping type according to claim 1, wherein: the outer circumferential face of the main rubber elastic body has tapered contours that gradually spread and extend in the axial direction from the first mounting member toward the second mounting member; a plurality of rubber elastic films extend from a middle section of the outer circumferential face of the main rubber elastic body so as to be affixed to the intermediate sleeve; the plurality of outer peripheral fluid chambers each have a wall partially defined by each of the rubber elastic films; and the rubber elastic films each have curving contours whose slope angle with respect to an axis-perpendicular direction progressively becomes larger toward the outer peripheral side viewed in vertical cross section.

3. The fluid-filled vibration-damping device of multidirectional vibration-damping type according to claim 2, wherein the plurality of rubber elastic films are provided independently of one another in a circumferential direction.

4. The fluid-filled vibration-damping device of multidirectional vibration-damping type according to claim 1, wherein in the intermediate sleeve, the window portion including the step portion has a notched portion in a frame thereof, and the second orifice passage communicates with the outer peripheral fluid chamber through the notched portion.

5. The fluid-filled vibration-damping device of multidirectional vibration-damping type according to claim 1, wherein: the second mounting member and the intermediate sleeve each have a stepped oval tubular shape; the plurality of outer peripheral fluid chambers comprise a pair of the outer peripheral fluid chambers; and the pair of the outer peripheral fluid chambers are positioned on opposite sides in a major axis direction of the second mounting member viewed in the axial direction.
